(19) United States
(12) Patent Application Publication
(10) Pub. No.: US 2025/0039648 A1
(43) Pub. Date: Jan. 30, 2025

(54) Mobility Management Method, Terminal, and Network Side Device

(71) Applicant: VIVO MOBILE COMMUNICATION CO., LTD., Dongguan (CN)

(72) Inventor: Huan Li, Dongguan (CN)

(21) Appl. No.: 18/914,639

(22) Filed: Oct. 14, 2024

Related U.S. Application Data
(63) Continuation of application No. PCT/CN2023/087653, filed on Apr. 11, 2023.

(30) Foreign Application Priority Data
Apr. 15, 2022 (CN) 202210400046.7

(51) Int. Cl. H04W 4/35; H04W 48/16; H04W 84/18

(52) U.S. Cl. CPC H04W 4/35; H04W 48/16; H04W 84/18

(57) ABSTRACT

A mobility management method includes determining, by a first network element, first information. The first information is used to indicate a target inventory device to inventory a target Internet of Things device; and sending, by the first network element, the first information to the target inventory device.

### CROSS-REFERENCE TO RELATED APPLICATIONS

This application is a Bypass Continuation application of International Patent Application No. PCT/CN2023/087653, filed Apr. 11, 2023, and claims priority to Chinese Patent Application No. 202210400046.7, filed Apr. 15, 2022, the disclosures of which are hereby incorporated by reference in their entireties.

### BACKGROUND OF THE INVENTION

### Field of the Invention

This application pertains to the field of communication technologies, and in particular, relates to a mobility management method, a terminal, and a network side device.

### Description of Related Art

A 3rd Generation Partner Project (3GPP) 5th generation (5G) system includes a terminal, an access network, and a core network. Mobility management of the core network on the terminal device may be classified into registration management and connection management. The terminal device needs to register with the core network before receiving a network service. The terminal device maintains a registration state in the network by executing a registration procedure including initial registration, periodic registration, and the like. When there is a non-access stratum (NAS) connection between the terminal device and a mobility management network element, the terminal device is in a connected state. Otherwise, the terminal device is in an idle state.

### SUMMARY OF THE INVENTION

According to a first aspect, a mobility management method is provided and is applied to a first network element. The method includes: determining, by a first network element, first information, where the first information is used to indicate a target inventory device to inventory a target Internet of Things device; and sending, by the first network element, the first information to the target inventory device.

According to a second aspect, a mobility management apparatus is provided. The mobility management apparatus includes: a determining module, configured to determine first information, where the first information is used to indicate a target inventory device to inventory a target Internet of Things device; and a sending module, configured to send the first information determined by the determining module to the target inventory device.

According to a third aspect, a mobility management method is provided and is applied to a target inventory device. The method includes: receiving, by a target inventory device, first information from a first network element, where the first information is used to indicate the target inventory device to inventory a target Internet of Things device; and inventorying, by the target inventory device, the target Internet of Things device according to the first information.

According to a fourth aspect, a mobility management apparatus is provided. The mobility management apparatus includes: a receiving module, configured to receive first information from a first network element, where the first information is used to indicate the mobility management apparatus to inventory a target Internet of Things device; and an inventory module, configured to inventory the target Internet of Things device according to the first information received by the receiving module.

According to a fifth aspect, a mobility management method is provided and is applied to a second network element. The method includes: sending, by a second network element, information from an Internet of Things service provider to a first network element, where the information from the Internet of Things service provider is used to determine first information, and the first information is used to indicate a target inventory device to inventory a target Internet of Things device, where the information from the Internet of Things service provider includes at least one of the following: identifier information of the target Internet of Things device; a use scenario of the target Internet of Things device; a service supported by the target Internet of Things device; a moving track of the target Internet of Things device; or a working time of the target Internet of Things device.

According to a sixth aspect, a mobility management apparatus is provided. The mobility management apparatus includes: a sending module, configured to send information from an Internet of Things service provider to a first network element, where the information from the Internet of Things service provider is used to determine first information, and the first information is used to indicate a target inventory device to inventory a target Internet of Things device, where the information from the Internet of Things service provider includes at least one of the following: identifier information of the target Internet of Things device; a use scenario of the target Internet of Things device; a service supported by the target Internet of Things device; a moving track of the target Internet of Things device; or a working time of the target Internet of Things device.

According to a seventh aspect, a network side device is provided. The network side device includes a processor and a memory, the memory stores a program or an instruction executable on the processor, and when the program or the instruction is executed by the processor, steps of the method according to the first aspect are implemented.

According to an eighth aspect, a network side device is provided, including a processor and a communication interface. The processor is configured to determine first information, where the first information is used to indicate a target inventory device to inventory a target Internet of Things device; and the communication interface is configured to send the first information to the target inventory device.

According to a ninth aspect, a terminal is provided. The terminal includes a processor and a memory, the memory stores a program or an instruction executable on the processor, and when the program or the instruction is executed by the processor, steps of the method according to the third aspect are implemented.

According to a tenth aspect, a terminal is provided, including a processor and a communication interface. The communication interface is configured to receive first information from a first network element, where the first information is used to indicate the terminal to inventory a target Internet of Things device; and the processor is configured to inventory the target Internet of Things device according to the first information.

According to an eleventh aspect, a network side device is provided. The network side device includes a processor and a memory, the memory stores a program or an instruction executable on the processor, and when the program or the instruction is executed by the processor, steps of the method according to the fifth aspect are implemented.

According to a twelfth aspect, a network side device is provided, including a processor and a communication interface. The communication interface is configured to send information from an Internet of Things service provider to a first network element, where the information from the Internet of Things service provider is used to determine first information, and the first information is used to indicate a target inventory device to inventory a target Internet of Things device, where the information from the Internet of Things service provider includes at least one of the following: identifier information of the target Internet of Things device; a use scenario of the target Internet of Things device; a service supported by the target Internet of Things device; a moving track of the target Internet of Things device; or a working time of the target Internet of Things device.

According to a thirteenth aspect, a mobility management system is provided, including a terminal and a network side device. The terminal may be configured to execute the steps of the method according to the first aspect, and the network side device may be configured to execute the steps of the method according to the third aspect or the steps of the method according to the fifth aspect.

According to a fourteenth aspect, a non-transitory readable storage medium is provided. The non-transitory readable storage medium stores a program or an instruction, and when the program or the instruction is executed by a processor, steps of the method according to the first aspect are implemented, the steps of the method according to the third aspect are implemented, or the steps of the method according to the fifth aspect are implemented.

According to a fifteenth aspect, a chip is provided. The chip includes a processor and a communication interface, the communication interface is coupled to the processor, and the processor is configured to run a program or an instruction to implement the method according to the first aspect, the method according to the third aspect, or the method according to the fifth aspect.

According to a sixteenth aspect, a computer program/program product is provided. The computer program/program product is stored in a non-transitory storage medium, and the computer program/program product is executed by at least one processor to implement the steps of the method according to the first aspect, the steps of the method according to the third aspect, or the steps of the method according to the fifth aspect.

### BRIEF DESCRIPTION OF THE DRAWINGS

FIG. 1 is a block diagram of a wireless communication system according to an embodiment of this application;

FIG. 2 is a first schematic diagram of a network architecture of a mobility management method according to an embodiment of this application;

FIG. 3 is a second schematic diagram of a network architecture of a mobility management method according to an embodiment of this application;

FIG. 4 is a first schematic flowchart of a mobility management method according to an embodiment of this application;

FIG. 5 is a second schematic flowchart of a mobility management method according to an embodiment of this application;

FIG. 6 is a third schematic flowchart of a mobility management method according to an embodiment of this application;

FIG. 7 is a fourth schematic flowchart of a mobility management method according to an embodiment of this application;

FIG. 8 is a fifth schematic flowchart of a mobility management method according to an embodiment of this application;

FIG. 9 is a sixth schematic flowchart of a mobility management method according to an embodiment of this application;

FIG. 10 is a seventh schematic flowchart of a mobility management method according to an embodiment of this application;

FIG. 11 is an eighth schematic flowchart of a mobility management method according to an embodiment of this application;

FIG. 12 is a ninth schematic flowchart of a mobility management method according to an embodiment of this application;

FIG. 13 is a first schematic structural diagram of a mobility management apparatus according to an embodiment of this application;

FIG. 14 is a second schematic structural diagram of a mobility management apparatus according to an embodiment of this application;

FIG. 15 is a third schematic structural diagram of a mobility management apparatus according to an embodiment of this application;

FIG. 16 is a schematic structural diagram of a communication device according to an embodiment of this application;

FIG. 17 is a schematic structural diagram of hardware of a terminal according to an embodiment of this application;

FIG. 18 is a first schematic structural diagram of hardware of a network side device according to an embodiment of this application; and

FIG. 19 is a second schematic structural diagram of hardware of a network side device according to an embodiment of this application.

### DESCRIPTION OF THE INVENTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe an order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th generation (6G) communication system.

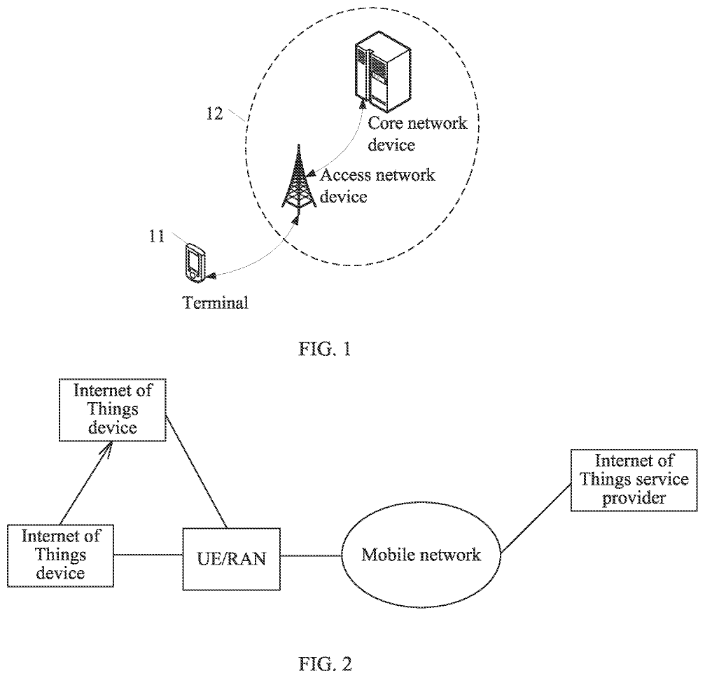

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a type of the terminal 11 is not limited in the embodiments of this application. The network side device 12 may include an access network device or a core network device. The access network device 12 may also be referred to as a radio access network device, a radio access network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmitting receiving point (TRP), or another appropriate term in the field. As long as a same technical effect is achieved, the base station is not limited to a specified technical term. It should be noted that, in this application, only a base station in an NR system is used as an example, and a type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rule function unit (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that, in the embodiments of this application, only a core network device in an NR system is used as an example for description, and a type of the core network device is not limited.

Currently, a terminal device needs to register with a core network before receiving a network service. The terminal device maintains a registration state in the network by executing a registration procedure, including initial registration, periodic registration, and the like. When there is a non-access stratum (NAS) connection between the terminal device and a mobility management network element, the terminal device is in a connected state. Otherwise, the terminal device is in an idle state.

Generally, Internet of Things terminals are terminal devices used in some specific scenarios or specific services. Internet of Things devices may be designed for specific requirements of services and applications that need to be executed (for example, a smart home/city, a smart utility, electronic health, and an intelligent wearable device), and some Internet of Things terminals may not be used for human communication, for example, an electronic meter reading device. Currently, in the registration procedure of the terminal device, the terminal device sends a registration request to the core network. However, many Internet of Things devices are only used in specific scenarios or specific services, and may not support a protocol stack (for example, a NAS protocol stack) of the existing 3GPP terminal device. For example, these Internet of Things devices may not able to actively communicate with the network. For example, the Internet of Things devices may send a reflection signal only after receiving an excitation signal from a reader/writer. Therefore, when these Internet of Things devices are within coverage of a 3GPP network, these Internet of Things devices cannot actively contact the network, and the network cannot know locations of these Internet of Things devices in real time.

In the embodiments of this application, a network side network element may first determine information used to indicate an inventory device to inventory some of the foregoing Internet of Things devices, and send the information to the inventory device, so that the inventory device may inventory the some Internet of Things devices, that is, a network element of the network side device may obtain location information of the some Internet of Things devices through the inventory device. Therefore, a problem that the network side device cannot know locations of the some Internet of Things devices in a timely manner can be resolved.

With reference to the accompanying drawings, the following describes in detail a mobility management method and apparatus, a terminal, a network side device, and a medium provided in the embodiments of this application by using some embodiments and application scenarios thereof.

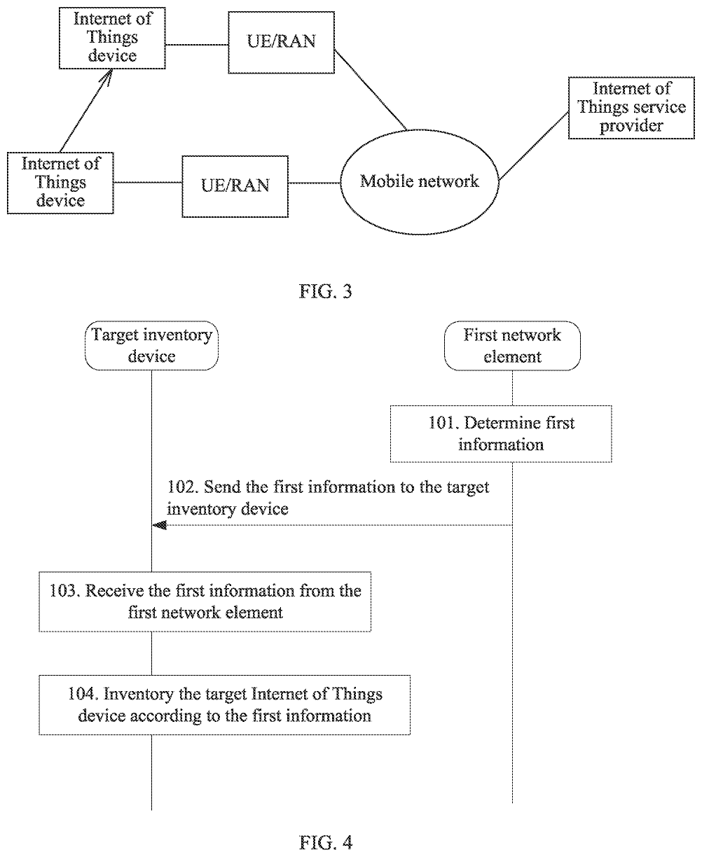

The mobility management method for an Internet of Things device provided in the embodiments of this application is applicable to the following network architecture. As shown in FIG. 2 and FIG. 3, the Internet of Things device accesses a mobile network through an inventory device. The inventory device may be user equipment (UE) or a radio access network (RAN).

FIG. 2 shows that a moving range of the Internet of Things device falls within a specific inventory device range, for example, an Internet of Things device installed within a factory building or moving within a factory building. FIG. 3 shows that a moving range of the Internet of Things device is greater than a range of a specific inventory device, for example, an Internet of Things device installed on a logistics vehicle.

FIG. 4 is a flowchart of a mobility management method according to an embodiment of this application. As shown in FIG. 4, the mobility management method provided in this embodiment of this application may include the following step 101 to step 104.

Step 101: A first network element determines first information.

Optionally, in this embodiment of this application, the first network element may be an access and mobility management function (AMF) network element.

In this embodiment of this application, the first information is used to indicate a target inventory device to inventory a target Internet of Things device.

Optionally, in this embodiment of this application, the target inventory device may be a specific inventory device, or may be all inventory devices within coverage of the first network element. The target inventory device may be one or more inventory devices.

The target inventory device may be any one of the following: UE, and a radio access network (RAN). In a case that the target inventory device is a plurality of inventory devices, the plurality of inventory devices may be all or a part of the foregoing items.

For example, if the target inventory device is a plurality of inventory devices, the plurality of inventory devices may be UE 1, UE 2, and UE 3; or the plurality of inventory devices may be UE 1, UE 2, and a RAN.

Optionally, in this embodiment of this application, the target Internet of Things device may be a specific Internet of Things device, or may be all Internet of Things devices within coverage of the target inventory device. The target Internet of Things device may be one or more Internet of Things devices.

Optionally, in this embodiment of this application, the first information may include at least one of the following: identifier information of the target Internet of Things device, an inventory range, information about the target inventory device, inventory time information, or inventory report information.

Optionally, in this embodiment of this application, the first information includes identifier information of the target Internet of Things device.

The identifier information may include at least one of the following: an internet protocol (IP) address, a subscription concealed identifier (SUCI), a subscription permanent identifier (SUPI), a generic public subscription identifier (GPSI), a permanent equipment identifier (PEI), a globally unique temporary identifier (GUTI), or the like.

The inventory range includes information about an inventory device that inventories the target Internet of Things device, and the inventory device that inventories the target Internet of Things device includes the target inventory device.

Optionally, in this embodiment of this application, the first information includes at least one of the following: information about the target inventory device, or inventory time information, where the inventory time information is time information of inventorying the target Internet of Things device by the target inventory device, where the inventory time information includes at least one of the following: an inventory period, an inventory start time, an inventory end time, or an inventory frequency.

The information about the target inventory device may be: identifier information of the target inventory device. It should be noted that for descriptions of the “identifier information”, refer to the descriptions in the foregoing embodiment. Details are not described herein again in this embodiment of this application.

The “inventorying the target Internet of Things device” may be understood as: sending an excitation signal to the target Internet of Things device, paging the target Internet of Things device, searching for the target Internet of Things device, or locating the target Internet of Things device. For example, how to send the excitation signal to the target Internet of Things device, how to page the target Internet of Things device, how to search for the target Internet of Things device, or how to locate the target Internet of Things device is implemented with reference to another scenario in which a signal is sent, a device is paged, a device is searched, or a device is located. Details are not described in this embodiment of this application. Through inventorying, an identifier or a state of the target Internet of Things device may be obtained, so that the first network element can obtain a correspondence between the target Internet of Things device and an inventory device.

For example, the inventory time information includes an inventory period. If the inventory period is 5 seconds, the inventory time information indicates that the target inventory device may inventory the target Internet of Things device once every 5 seconds.

For another example, the inventory time information includes an inventory start time and an inventory end time. If the inventory start time is 8 a.m., and the inventory end time is 8 p.m., the inventory time information indicates that the target inventory device may inventory the target Internet of Things device in a time period from 8 a.m. to 8 p.m.

For another example, the inventory time information includes an inventory frequency. If the inventory frequency is 10 times per minute, the inventory time information indicates that the target inventory device may inventory the target Internet of Things device 10 times per minute.

The inventory report information is used to indicate a manner in which the target inventory device sends a result of inventorying the target Internet of Things device. It should be noted that for descriptions of the inventory report information, refer to the following descriptions in step 201a. Details are not described in this embodiment of this application.

Step 102: The first network element sends the first information to the target inventory device.

Optionally, in this embodiment of this application, the first network element may send the first information to the target inventory device by using a target message. It can be understood that the target message includes the first information.

In a case that the target inventory device is UE, the target message may be any one of the following: a non-access stratum (NAS) message, an Internet of Things device registration message, and a configuration update request message. In a case that the target inventory device is a RAN, the target message may be any one of the following: a new generation (NG) application protocol (NGAP) message, and a configuration information request message.

Step 103: The target inventory device receives the first information from the first network element.

In this embodiment of this application, the first information is used to indicate the target inventory device to inventory the target Internet of Things device.

Step 104: The target inventory device inventories the target Internet of Things device according to the first information.

In an example, in a case that the first information includes the identifier information of the target Internet of Things device, the target Internet of Things device may be a specific Internet of Things device.

In another example, in a case that the first information does not include the identifier information of the target Internet of Things device, the target Internet of Things device may be all or a part of Internet of Things devices within coverage of the target inventory device.

Optionally, in this embodiment of this application, the target inventory device may send an excitation signal to the target Internet of Things device according to the first information, so as to inventory the target Internet of Things device.

Optionally, in this embodiment of this application, after the target inventory device inventories the target Internet of Things device, step 101 to step 104 may be further performed again. That is, the first network element may update the first information, and send the updated first information to the target inventory device again, so that the target inventory device can receive the updated first information, and inventory the target Internet of Things device again according to the updated first information.

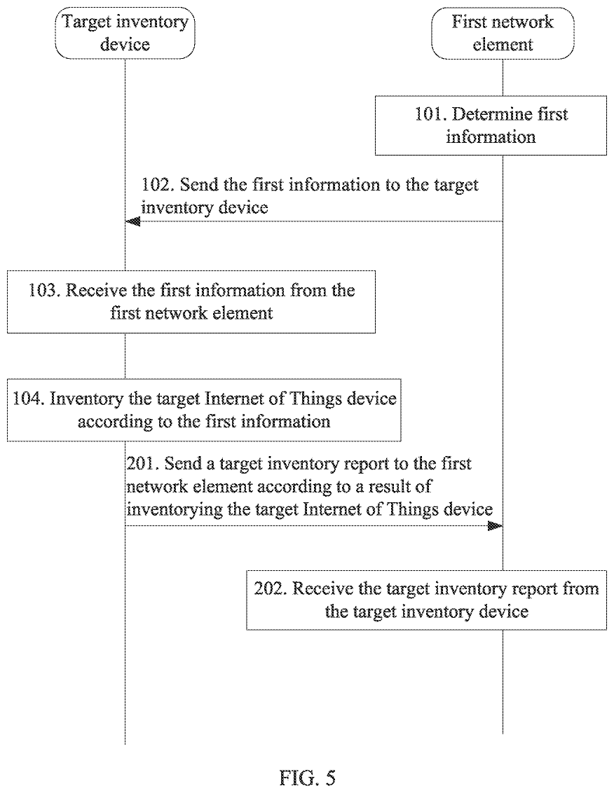

Optionally, in this embodiment of this application, after the target inventory device inventories the target Internet of Things device, the target inventory device may further send an inventory result to the first network element, so that the first network element can obtain information about the target Internet of Things device (for example, location information). With reference to FIG. 4, as shown in FIG. 5, after the foregoing step 104, the mobility management method provided in this embodiment of this application may further include the following step 201 and step 202.

Step 201: The target inventory device sends a target inventory report to the first network element according to a result of inventorying the target Internet of Things device.

Optionally, in this embodiment of this application, the target inventory report may be a first inventory report or a second inventory report, where the first inventory report indicates that the target Internet of Things device is inventoried by the target inventory device, and the second inventory report indicates that the target Internet of Things device is not inventoried by the target inventory device.

For example, the target inventory device sends an excitation signal to the target Internet of Things device. In a case that the target inventory device receives a reflection signal (that is, a reflection signal for sending the excitation signal to the target Internet of Things device, where the reflection signal includes the identifier information of the target Internet of Things device) from the target Internet of Things device within a predetermined time period, the target inventory report is the first inventory report; otherwise, in a case that the target inventory device does not receive a reflection signal from the target Internet of Things device within a predetermined time period, the target inventory report is the second inventory report.

For example, the target inventory device pages the target Internet of Things device. In a case that the target inventory device receives a response message of the paging message, the target inventory device sends the first inventory report; otherwise, the target inventory device sends the second inventory report.

For example, the target inventory device searches for or locates the target Internet of Things device. In a case that the target inventory device successfully finds the target Internet of Things device or receives location information of the target Internet of Things device, the target inventory device sends the first inventory report; otherwise, the target inventory device sends the second inventory report.

Optionally, in this embodiment of this application, the target inventory device may send the target inventory report to the first network element by using a first message.

In a case that the target inventory device is UE, the first message may be a NAS message. In a case that the target inventory device is a RAN, the first message may be an NGAP message.

Optionally, in this embodiment of this application, the target inventory report includes at least one of the following:
identifier information of the target Internet of Things device; or
a target inventory indication.

In this embodiment of this application, the target inventory indication is used to indicate any one of the following that: the target Internet of Things device is inventoried by the target inventory device, and the target Internet of Things device is not inventoried by the target inventory device.

Optionally, in this embodiment of this application, in a case that the target inventory report is the first inventory report, the target inventory indication is used to indicate that the target Internet of Things device is inventoried by the target inventory device. In a case that the target inventory report is the second inventory report, the target inventory indication is used to indicate that the target Internet of Things device is not inventoried by the target inventory device.

Optionally, in this embodiment of this application, the first information includes inventory report information, and the inventory report information is used to indicate a target manner in which the target inventory device sends the target inventory report. The foregoing step 201 may be implemented by the following step 201a.

Step 201a: The target inventory device sends the target inventory report to the first network element in the target manner according to the result of inventorying the target Internet of Things device.

In this embodiment of this application, the target manner includes at least one of the following:
one-time reporting;
periodic reporting;
performing reporting when the target Internet of Things device is inventoried;
reporting a first inventory report;
reporting a second inventory report;
a reporting period of the target inventory report;
a reporting start time of the target inventory report;
a reporting end time of the target inventory report; or a reporting frequency of the target inventory report.

The “one-time reporting” may be understood as: the target inventory device sends the target inventory report to the first network element once. The “periodic reporting” may be understood as: the target inventory device may send the target inventory report to the first network element for a plurality of times according to a predetermined period.

The first inventory report indicates that the target Internet of Things device is inventoried by the target inventory device, and the second inventory report indicates that the target Internet of Things device is not inventoried by the target inventory device.

For example, in a case that the target manner is reporting the first inventory report, if the target inventory report is the first inventory report, the target inventory device may send the first inventory report to the first network element; or if the target inventory report is the second inventory report, the target inventory device cannot send the second inventory report to the first network element.

For another example, in a case that the target manner is reporting the second inventory report, if the target inventory report is the first inventory report, the target inventory device cannot send the first inventory report to the first network element; or if the target inventory report is the second inventory report, the target inventory device may send the second inventory report to the first network element.

In this embodiment of this application, the target inventory report is used by the first network element to update a first correspondence, and the first correspondence is a correspondence between the target Internet of Things device and an inventory device.

Step 202: The first network element receives the target inventory report from the target inventory device.

In this embodiment of this application, the target inventory report includes the result of inventorying the target Internet of Things device by the target inventory device.

In this way, it can be learned that the target inventory device may send the target inventory report to the first network element according to the result of inventorying the target Internet of Things device. Therefore, the first network element may directly obtain a correspondence between the target Internet of Things device and the target inventory device according to the target inventory report.

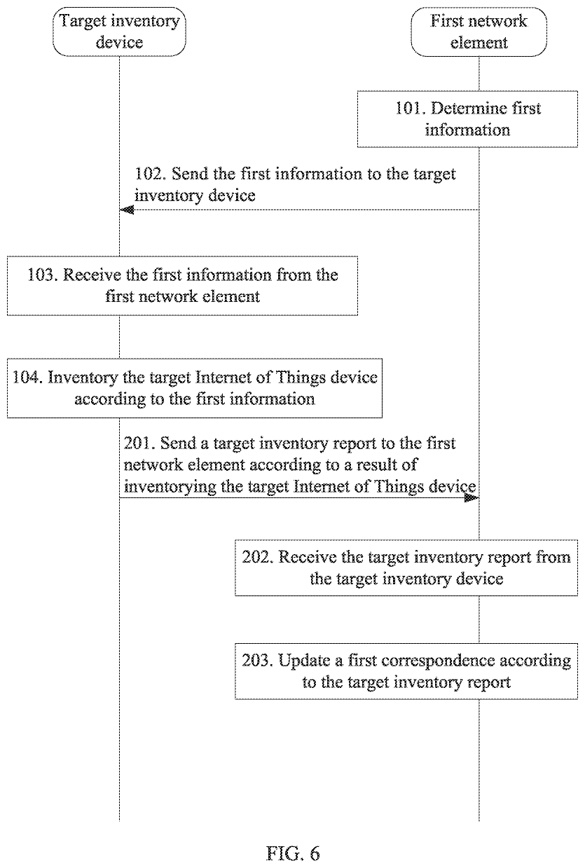

Optionally, in this embodiment of this application, with reference to FIG. 5, as shown in FIG. 6, after the foregoing step 202, the mobility management method provided in this embodiment of this application may further include the following step 203.

Step 203: The first network element updates a first correspondence according to the target inventory report.

In this embodiment of this application, the first correspondence is a correspondence between the target Internet of Things device and an inventory device.

For example, in this embodiment of this application, the first correspondence is a correspondence between the target Internet of Things device and a first inventory device, where the first inventory device is an inventory device that is stored in the first network element and that is capable of inventorying the target Internet of Things device. In other words, the first inventory device is an inventory device that is related to the target Internet of Things device and that is obtained when the first network element determines the first information.

Optionally, in this embodiment of this application, in a case that the target inventory report is the first inventory report, the first network element may update the correspondence (that is, the first correspondence) between the target Internet of Things device and the first inventory device to the correspondence (that is, a second correspondence in the following embodiment) between the target Internet of Things device and the target inventory device, so as to update the first correspondence.

Optionally, in this embodiment of this application, in a case that the target inventory report is the second inventory report, the first network element may delete the correspondence (that is, the first correspondence) between the target Internet of Things device and the inventory device, so as to update the first correspondence.

The following uses an example to describe how the first network element stores the first correspondence.

Optionally, in this embodiment of this application, before the foregoing step 203, the mobility management method provided in this embodiment of this application may further include the following step 301.

Step 301: The first network element receives identifier information of the target Internet of Things device from the first inventory device.

Optionally, in this embodiment of this application, the first inventory device may be an inventory device in the target inventory device, or may be an inventory device other than the target inventory device.

Optionally, in this embodiment of this application, the first inventory device or another transmit end may send an excitation signal to the target Internet of Things device, so that the target Internet of Things device may send the identifier information of the target Internet of Things device by using a reflection signal of the excitation signal. The first inventory device receives the identifier information of the target Internet of Things device, and sends the identifier information of the target Internet of Things device to the first network element. The first network element may receive the identifier information of the target Internet of Things device.

The first inventory device may send the identifier information of the target Internet of Things device to the first network element by using a NAS message.

For example, the first inventory device may send an Internet of Things device registration message to the first network element, where the Internet of Things device registration message includes the identifier information of the target Internet of Things device.

Step 302: The first network element stores the first correspondence.

The following uses an example in which the target inventory report is the first inventory report to describe how the first network element updates the first correspondence.

Optionally, in this embodiment of this application, the target inventory report is a first inventory report, and the first inventory report indicates that the target Internet of Things device is inventoried. The foregoing step 203 may be implemented by the following step 203a.

Step 203a: The first network element updates the first correspondence to a second correspondence according to the target inventory report.

In this embodiment of this application, the second correspondence is a correspondence between the target Internet of Things device and the target inventory device.

In this embodiment of this application, if the target Internet of Things device is inventoried by the target inventory device, the first network element may update the first correspondence to the second correspondence. In addition, it may be considered that the location information of the target Internet of Things device has changed. Therefore, the first network element may also update the location information of the target Internet of Things device. For example, the first network element uses, as the location information of the target Internet of Things device, the target inventory device that inventories the target Internet of Things device.

In this way, because the first network element may update the correspondence (that is, the first correspondence) between the target Internet of Things device and the inventory device to a correspondence between the target Internet of Things device and an inventory device (that is, the target inventory device) that inventories the target Internet of Things device, the updated location information of the target Internet of Things device may be obtained through the inventory device that inventories the target Internet of Things device, so that the location information of the target Internet of Things device can be obtained in a timely manner, so as to perform mobility management on the target Internet of Things device.

It should be noted that the target inventory device may include a transmit end and/or a receive end. For example, the transmit end sends an excitation signal to the target Internet of Things device, and the receive end receives a reflection signal from the target Internet of Things device. The transmit end and the receive end may be a same device or different devices. The receive end receives the reflection signal from the target Internet of Things device, and the receive end may send the target inventory report to the first network element (in this case, the transmit end is the one that inventories the target Internet of Things device or that sends an inventory message to the target Internet of Things device in this embodiment of this application). The receive end may also send, to the transmit end, data that is carried in the reflection signal and that is from the target Internet of Things device, and then the transmit end sends the target inventory report to the first network element.

If the transmit end and the receive end in the network may be different devices, the first network element may send the first information with the same content to both the transmit end and the receive end, or may send the first information with different content, or send the first information only to the transmit end or the receive end. If the transmit end and the receive end in the network may be different devices, the target inventory device in step 102 and step 201 in this embodiment of this application may be different. For example, the first information sent by the first network element to the transmit end may include at least one of information about the target inventory device or inventory time information, and the first information sent by the first network element to the receive end may include information about the target inventory device and inventory report information.

It should be noted that the target inventory device and the target Internet of Things device in this embodiment of this application may be contacted by using a 3GPP technology or a non-3GPP technology.

According to the mobility management method provided in this embodiment of this application, a first network element may determine first information used to indicate a target inventory device to inventory a target Internet of Things device, and send the first information to the target inventory device, so that the target inventory device can inventory the target Internet of Things device according to the first information. In a case that the target Internet of Things device exists within coverage of the first network element, the first network element sends the first information to the target inventory device, so that the target inventory device can inventory the target Internet of Things device, that is, the first network element can obtain location information of the target Internet of Things device through the target inventory device. Therefore, a problem that a network side device cannot obtain a location of the target Internet of Things device in a timely manner can be resolved.

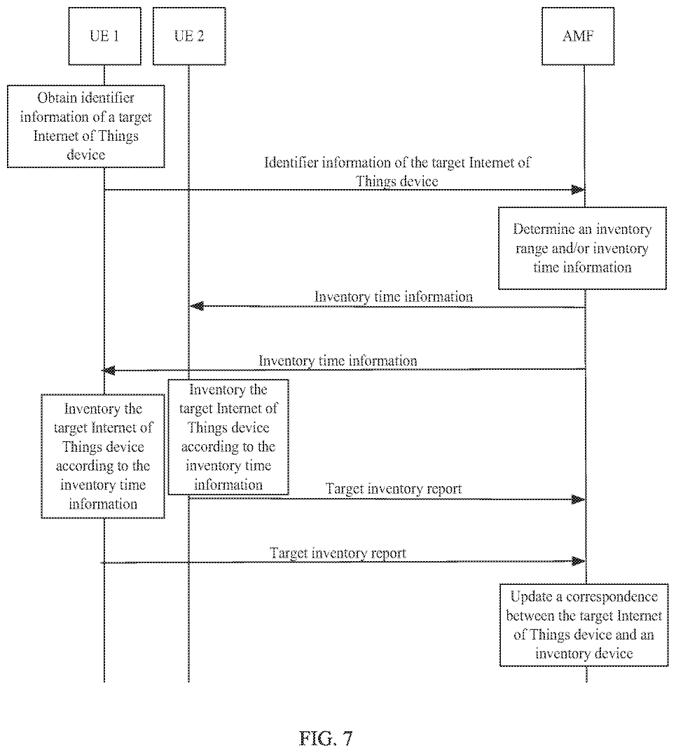

It should be noted that, to describe the mobility management method in this embodiment of this application more clearly, FIG. 7 is a schematic flowchart of a mobility management method. An example in which an inventory device is UE is used for description. As shown in FIG. 7, a first inventory device (for example, UE 1) may first obtain identifier information of a target Internet of Things device, and send the identifier information of the target Internet of Things device to a first network element (for example, an AMF). In this way, the AMF may determine an inventory range and/or inventory time information, and separately send, according to information about inventory devices (for example, the UE 1 and a target inventory device (for example, UE 2)) that inventory the target Internet of Things device in the inventory range, the inventory time information to the UE 1 and the UE 2, so that the UE 1 and the UE 2 can separately inventory the target Internet of Things device according to the inventory time information and separately send a target inventory report to the AMF, and the AMF network element can update a correspondence between the target Internet of Things device and an inventory device.

The following provides an example in which the first network element determines the first information for description.

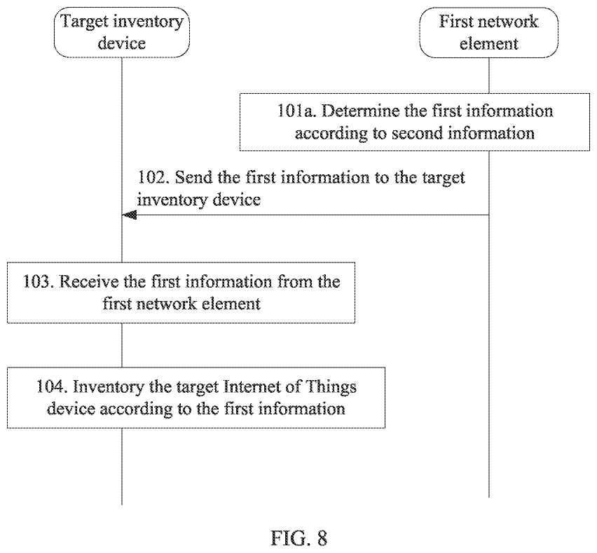

Optionally, in this embodiment of this application, the first information is determined by the first network element according to second information. With reference to FIG. 4, as shown in FIG. 8, the foregoing step 101 may be implemented by the following step 101a.

Step 101a: The first network element determines the first information according to second information.

In this embodiment of this application, the second information includes at least one of the following:
information about an inventory device within coverage of the first network element; information about an inventory device currently corresponding to the target Internet of Things device;
a use scenario of the target Internet of Things device;
a service supported by the target Internet of Things device;
a moving track of the target Internet of Things device; or
a working time of the target Internet of Things device.

The information about the inventory device within the coverage of the first network element may be any one of the following: location information of the inventory device within the coverage of the first network element, and identifier information of the inventory device within the coverage of the first network element.

The information about the inventory device currently corresponding to the target Internet of Things device may be any one of the following: location information of the inventory device currently corresponding to the target Internet of Things device, and identifier information of the inventory device currently corresponding to the target Internet of Things device.

The following uses an example in which the first information is information about the target inventory device for description.

Optionally, in this embodiment of this application, the foregoing step 101a may be implemented by the following step 101a1.

Step 101a1: The first network element determines an inventory range according to the second information.

In this embodiment of this application, the inventory range includes information about an inventory device that inventories the target Internet of Things device; and the inventory device that inventories the target Internet of Things device includes the target inventory device.

It can be understood that the first network element may determine, according to the second information, the inventory device that inventories the target Internet of Things device from the inventory device within the coverage of the first network element. The target inventory device may be any inventory device that inventories the target Internet of Things device.

Optionally, in this embodiment of this application, in a case that the second information is the information about the inventory device currently corresponding to the target Internet of Things device, the first network element may determine the information about the inventory device currently corresponding to the target Internet of Things device as the inventory range.

In this way, it can be learned that the first network element may determine, according to the second information, information about some inventory devices that inventory the target Internet of Things device, so as to indicate the some inventory devices to inventory the target Internet of Things device. Therefore, efficiency of inventorying the target Internet of Things device can be improved.

Certainly, the first network element may first obtain the second information and then determines the first information according to the second information.

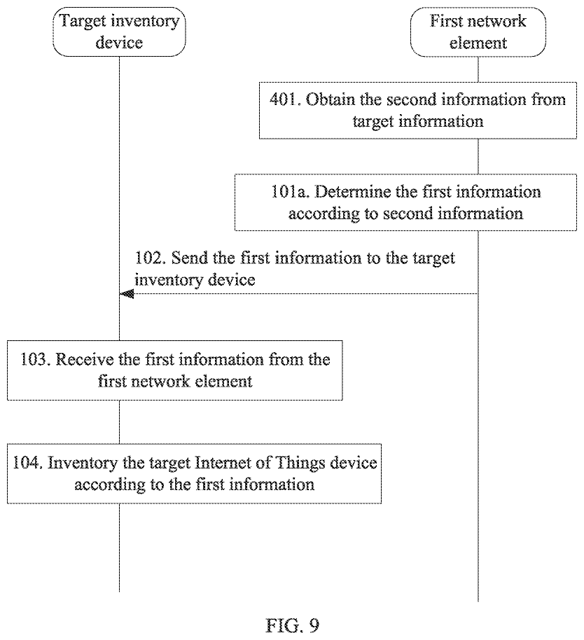

Optionally, in this embodiment of this application, with reference to FIG. 8, as shown in FIG. 9, before the foregoing step 101a, the mobility management method provided in this embodiment of this application may further include the following step 401.

Step 401: The first network element obtains the second information from target information.

In this embodiment of this application, the target information includes at least one of the following: local storage information, operator configuration information, information from an Internet of Things service provider, information from an operator management network element, or information about an inventory device registered with the first network element.

The information from the Internet of Things service provider includes at least one of the following:
the identifier information of the target Internet of Things device;
the use scenario of the target Internet of Things device;
the service supported by the target Internet of Things device;
the moving track of the target Internet of Things device; or
the working time of the target Internet of Things device.

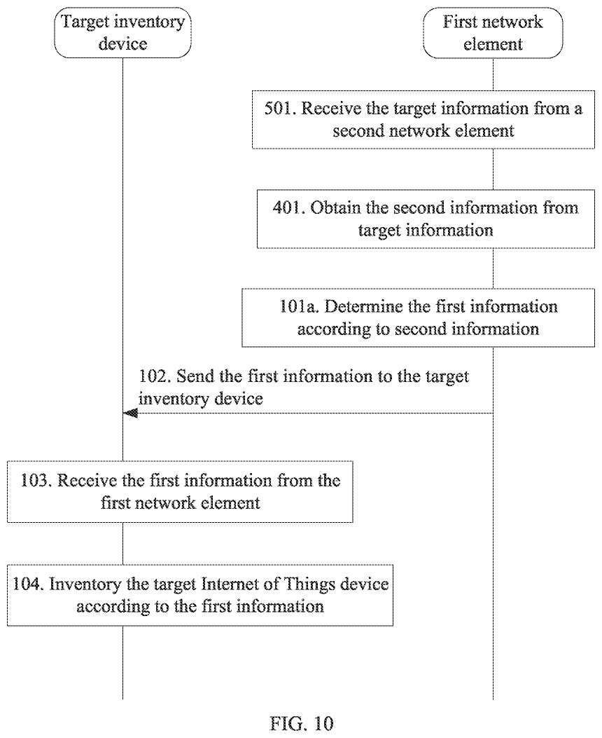

Optionally, in this embodiment of this application, with reference to FIG. 9, as shown in FIG. 10, before step 401, the mobility management method provided in this embodiment of this application may further include the following step 501.

Step 501: The first network element receives the target information from a second network element.

In this embodiment of this application, the second network element includes any one of the following: a unified data management (UDM) network element and a policy control function (PCF) network element.

Optionally, in this embodiment of this application, after the first network element receives the target information, the first network element may store the target information.

The following uses an example to describe how the first network element receives the information from the Internet of Things service provider from the second network element.

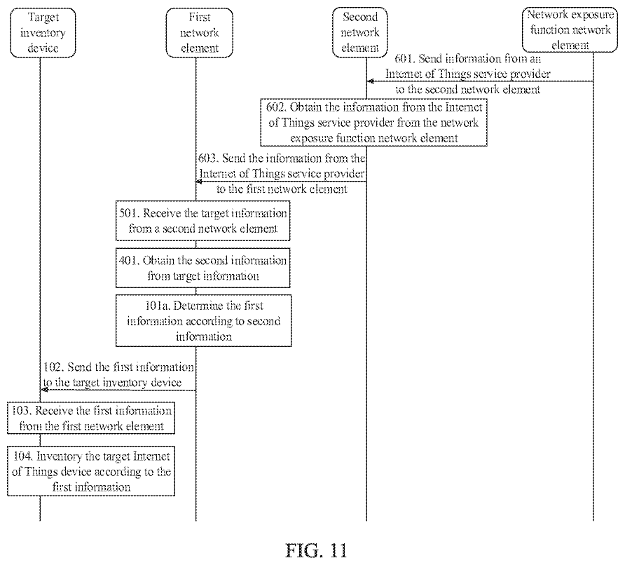

Optionally, in this embodiment of this application, with reference to FIG. 10, as shown in FIG. 11, before the foregoing step 501, the mobility management method provided in this embodiment of this application may further include the following step 601 to step 603.

Step 601: A network exposure function network element sends information from an Internet of Things service provider to the second network element.

Step 602: The second network element obtains the information from the Internet of Things service provider from the network exposure function network element.

Optionally, in this embodiment of this application, a service provider of an Internet of Things device or an enterprise to which an Internet of Things device belongs may first send the information from the Internet of Things service provider to the network exposure function (NEF) network element, so that the second network element can obtain the information from the Internet of Things service provider from the network exposure function network element.

Optionally, in this embodiment of this application, after the second network element obtains the information from the Internet of Things service provider, the second network element may store the information from the Internet of Things service provider.

Optionally, in this embodiment of this application, after the second network element obtains the information from the Internet of Things service provider, the second network element may send the information from the Internet of Things service provider to a unified data repository (UDR), so that the UDR may store the information from the Internet of Things service provider.

Step 603: The second network element sends the information from the Internet of Things service provider to the first network element.

In this embodiment of this application, the information from the Internet of Things service provider is used to determine first information, and the first information is used to indicate a target inventory device to inventory a target Internet of Things device. The information from the Internet of Things service provider may also be referred to as use information of an Internet of Things device.

The information from the Internet of Things service provider includes at least one of the following:
identifier information of the target Internet of Things device;
a use scenario of the target Internet of Things device;
a service supported by the target Internet of Things device;
a moving track of the target Internet of Things device; or
a working time of the target Internet of Things device.

In this embodiment of this application, the second network element includes any one of the following: a unified data management (UDM) network element and a policy control function (PCF) network element.

According to the mobility management method provided in this embodiment of this application, a second network element may obtain information from an Internet of Things service provider from a network exposure function network element, and send the information to a first network element, where the information is used to determine first information (the first information is used to indicate a target inventory device to inventory a target Internet of Things device), and the information from the Internet of Things service provider includes at least one of identifier information of the target Internet of Things device, a use scenario of the target Internet of Things device, a service supported by the target Internet of Things device, a moving track of the target Internet of Things device, or a working time of the target Internet of Things device, so that the second network element can determine the first information. The second network element may obtain and send, to the first network element, the information that is from the Internet of Things service provider and that is used to determine the first information. In this way, in a case that the target Internet of Things device exists within coverage of the first network element, the first network element sends the first information to the target inventory device, so that the target inventory device can inventory the target Internet of Things device. Through the mobility management solution for the Internet of Things device described in this embodiment of this application, the first network element may obtain location information of the target Internet of Things device by using the target inventory device.

Optionally, in this embodiment of this application, before the foregoing step 601, the mobility management method provided in this embodiment of this application may further include the following step 701 and step 702.

Step 701: The second network element receives a target request message from the first network element.

In this embodiment of this application, the target request message includes the identifier information of the target Internet of Things device.

Step 702: The second network element obtains the information from the Internet of Things service provider according to the identifier information of the target Internet of Things device.

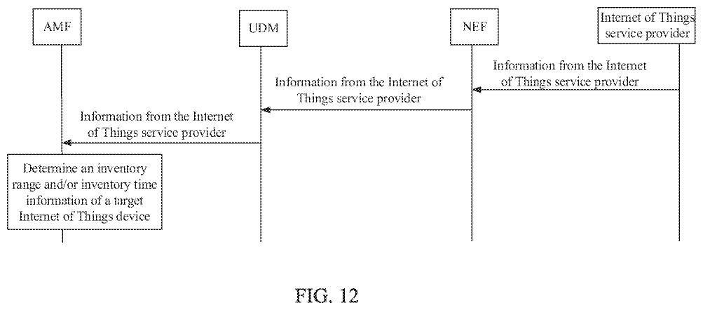

It should be noted that, to describe the mobility management method in this embodiment of this application more clearly, FIG. 12 is a schematic flowchart of a mobility management method. An example in which a first network element is an AMF network element, a second network element is a UDM network element, and target information is information from an Internet of Things service provider is used for description. As shown in FIG. 12, the Internet of Things service provider sends the information from the Internet of Things service provider to an NEF network element, so that the NEF network element may send the information from the Internet of Things service provider to the UDM network element, the UDM network element may send the information from the Internet of Things service provider to the AMF network element, and the AMF network element may determine an inventory range and/or inventory time information.

The mobility management method provided in the embodiments of this application may be executed by a mobility management apparatus. In the embodiments of this application, an example in which the mobility management apparatus executes the mobility management method is used to describe the mobility management apparatus provided in the embodiments of this application.

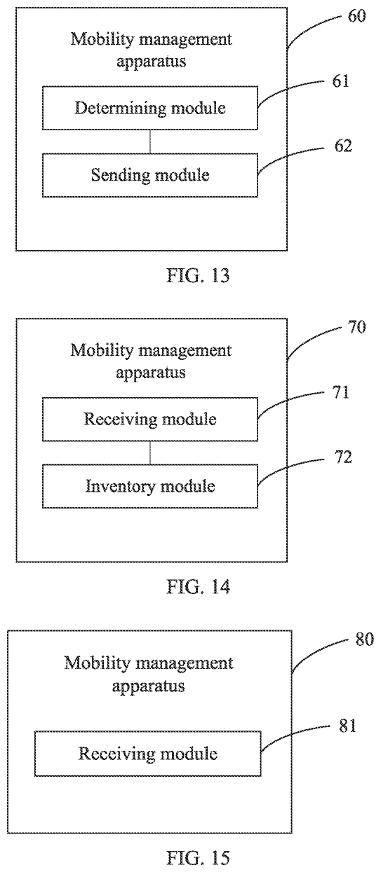

FIG. 13 is a possible schematic structural diagram of a mobility management apparatus according to an embodiment of this application. As shown in FIG. 13, the mobility management apparatus 60 may include: a determining module 61, configured to determine first information, where the first information is used to indicate a target inventory device to inventory a target Internet of Things device; and a sending module 62, configured to send the first information determined by the determining module 61 to the target inventory device.

In a possible implementation, the first information includes identifier information of the target Internet of Things device.

In a possible implementation, the first information includes at least one of the following: information about the target inventory device, or inventory time information, where the inventory time information is time information of inventorying the target Internet of Things device by the target inventory device, where the inventory time information includes at least one of the following: an inventory period, an inventory start time, an inventory end time, or an inventory frequency.

In a possible implementation, the determining module 61 is configured to determine the first information according to second information, where the second information includes at least one of the following: information about an inventory device within coverage of the mobility management apparatus 60; information about an inventory device currently corresponding to the target Internet of Things device; a use scenario of the target Internet of Things device; a service supported by the target Internet of Things device; a moving track of the target Internet of Things device; or a working time of the target Internet of Things device.

In a possible implementation, the determining module 61 is configured to determine an inventory range according to the second information, where the inventory range includes information about an inventory device that inventories the target Internet of Things device, where the inventory device that inventories the target Internet of Things device includes the target inventory device.

In a possible implementation, the mobility management apparatus 60 may further include an obtaining module, configured to obtain the second information from target information, where the target information includes at least one of the following: local storage information, operator configuration information, information from an Internet of Things service provider, information from an operator management network element, or information about an inventory device registered with the mobility management apparatus 60; and the information from the Internet of Things service provider includes at least one of the following: the identifier information of the target Internet of Things device; the use scenario of the target Internet of Things device; the service supported by the target Internet of Things device; the moving track of the target Internet of Things device; or the working time of the target Internet of Things device.

In a possible implementation, the mobility management apparatus 60 may further include a receiving module, configured to receive the target information from a second network element, where the second network element includes any one of the following: a unified data management network element and a policy control function network element.

In a possible implementation, the mobility management apparatus 60 may further include a receiving module, configured to receive a target inventory report from the target inventory device, where the target inventory report includes a result of inventorying the target Internet of Things device by the target inventory device.

In a possible implementation, the mobility management apparatus 60 may further include an update module, configured to update a first correspondence according to the target inventory report, where the first correspondence is a correspondence between the target Internet of Things device and an inventory device.

In a possible implementation, the first correspondence is a correspondence between the target Internet of Things device and a first inventory device; and the first inventory device is an inventory device that is stored in the mobility management apparatus 60 and that is capable of inventorying the target Internet of Things device.

In a possible implementation, the receiving module is further configured to receive identifier information of the target Internet of Things device from the first inventory device. The mobility management apparatus 60 may further include a storage module, configured to store the first correspondence received by the receiving module.

In a possible implementation, the target inventory report is a first inventory report, and the first inventory report indicates that the target Internet of Things device is inventoried; and the update module is configured to update the first correspondence to a second correspondence according to the target inventory report, where the second correspondence is a correspondence between the target Internet of Things device and the target inventory device.

In a possible implementation, the target inventory report includes at least one of the following: identifier information of the target Internet of Things device; or a target inventory indication, where the target inventory indication is used to indicate any one of the following that: the target Internet of Things device is inventoried by the target inventory device, and the target Internet of Things device is not inventoried by the target inventory device.

In a possible implementation, the first information includes inventory report information, and the inventory report information is used to indicate a target manner in which the target inventory device sends the target inventory report, where the target manner includes at least one of the following: one-time reporting; periodic reporting; performing reporting when the target Internet of Things device is inventoried; reporting a first inventory report; reporting a second inventory report; a reporting period of the target inventory report; a reporting start time of the target inventory report; a reporting end time of the target inventory report; or a reporting frequency of the target inventory report, where the first inventory report indicates that the target Internet of Things device is inventoried, and the second inventory report indicates that the target Internet of Things device is not inventoried.

According to the mobility management apparatus provided in this embodiment of this application, in a case that a target Internet of Things device exists within coverage of the mobility management apparatus, the mobility management apparatus sends first information to a target inventory device, so that the target inventory device can inventory the target Internet of Things device, that is, the mobility management apparatus can obtain location information of the target Internet of Things device through the target inventory device. Therefore, a problem that a network side device cannot obtain a location of the target Internet of Things device in a timely manner can be resolved.

The mobility management apparatus in this embodiment of this application may be an electronic device, for example, an electronic device with an operating system, or may be a component in the electronic device, for example, an integrated circuit or a chip. The electronic device may be a network side device, or another device other than the network side device. For example, the network side device may include but is not limited to the type of the network side device 12 listed above. The another device may be a server, a network attached storage (NAS), or the like. This is not limited in this embodiment of this application.

The mobility management apparatus provided in this embodiment of this application can implement the processes implemented in the method embodiments in FIG. 1 to FIG. 12, and achieve a same technical effect. To avoid repetition, details are not described herein again.

FIG. 14 is a possible schematic structural diagram of a mobility management apparatus according to an embodiment of this application. As shown in FIG. 14, the mobility management apparatus 70 may include: a receiving module 71, configured to receive first information from a first network element, where the first information is used to indicate the mobility management apparatus 70 to inventory a target Internet of Things device; and an inventory module 72, configured to inventory the target Internet of Things device according to the first information received by the receiving module 71.

In a possible implementation, the first information includes identifier information of the target Internet of Things device.

In a possible implementation, the first information includes at least one of the following: information about the mobility management apparatus 70, or inventory time information, where the inventory time information is time information of inventorying the target Internet of Things device by the mobility management apparatus 70, where the inventory time information includes at least one of the following: an inventory period, an inventory start time, an inventory end time, or an inventory frequency.

In a possible implementation, the first information is determined by the first network element according to second information, where the second information includes at least one of the following: information about an inventory device within coverage of the first network element; information about an inventory device currently corresponding to the target Internet of Things device; a use scenario of the target Internet of Things device; a service supported by the target Internet of Things device; a moving track of the target Internet of Things device; or a working time of the target Internet of Things device.

In a possible implementation, the mobility management apparatus 70 may further include a sending module, configured to send a target inventory report to the first network element according to a result of inventorying the target Internet of Things device, where the target inventory report is used by the first network element to update a first correspondence, and the first correspondence is a correspondence between the target Internet of Things device and an inventory device.

In a possible implementation, the first correspondence is a correspondence between the target Internet of Things device and a first inventory device, where the first inventory device is an inventory device that is stored in the first network element and that is capable of inventorying the target Internet of Things device.

In a possible implementation, the target inventory report includes at least one of the following: identifier information of the target Internet of Things device; or a target inventory indication, where the target inventory indication is used to indicate any one of the following that: the target Internet of Things device is inventoried by the mobility management apparatus 70, and the target Internet of Things device is not inventoried by the mobility management apparatus 70.

In a possible implementation, the first information includes inventory report information, and the inventory report information is used to indicate a target manner in which the mobility management apparatus 70 sends the target inventory report. The sending module is configured to send the target inventory report to the first network element in the target manner, where the target manner includes at least one of the following: one-time reporting; periodic reporting; performing reporting when the target Internet of Things device is inventoried; reporting a first inventory report; reporting a second inventory report; a reporting period of the target inventory report; a reporting start time of the target inventory report; a reporting end time of the target inventory report; or a reporting frequency of the target inventory report, where the first inventory report indicates that the target Internet of Things device is inventoried by the mobility management apparatus 70, and the second inventory report indicates that the target Internet of Things device is not inventoried by the mobility management apparatus 70.

According to the mobility management apparatus provided in this embodiment of this application, in a case that a target Internet of Things device exists within coverage of a first network element, the first network element sends first information to the mobility management apparatus, so that the mobility management apparatus can inventory the target Internet of Things device, that is, the first network element can obtain location information of the target Internet of Things device through the mobility management apparatus. Therefore, a problem that a network side device cannot obtain a location of the target Internet of Things device in a timely manner can be resolved.

The mobility management apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the type of the terminal 11 listed above. The another device may be a server, a network attached storage (NAS), or the like. This is not limited in this embodiment of this application.

The mobility management apparatus provided in this embodiment of this application can implement the processes implemented in the method embodiments in FIG. 1 to FIG. 12, and achieve a same technical effect. To avoid repetition, details are not described herein again.

FIG. 15 is a possible schematic structural diagram of a mobility management apparatus according to an embodiment of this application. As shown in FIG. 15, the mobility management apparatus 80 may include: a sending module 81, configured to send information from an Internet of Things service provider to a first network element, where the information from the Internet of Things service provider is used to determine first information, and the first information is used to indicate a target inventory device to inventory a target Internet of Things device, where the information from the Internet of Things service provider includes at least one of the following: identifier information of the target Internet of Things device; a use scenario of the target Internet of Things device; a service supported by the target Internet of Things device; a moving track of the target Internet of Things device; or a working time of the target Internet of Things device.

In a possible implementation, the mobility management apparatus 80 includes any one of the following: a unified data management network element and a policy control function network element.

In a possible implementation, the mobility management apparatus 80 may further include: a receiving module, configured to receive a target request message from the first network element, where the target request message includes the identifier information of the target Internet of Things device; and an obtaining module, configured to obtain the information from the Internet of Things service provider according to the identifier information of the target Internet of Things device.

In a possible implementation, the mobility management apparatus 80 may further include an obtaining module, configured to obtain the information from the Internet of Things service provider from a network exposure function network element.

According to the mobility management apparatus provided in this embodiment of this application, the mobility management apparatus may obtain and send, to a first network element, information that is from an Internet of Things service provider and that is used to determine first information. In this way, in a case that a target Internet of Things device exists within coverage of the first network element, the first network element sends the first information to a target inventory device, so that the target inventory device can inventory the target Internet of Things device, that is, the first network element can obtain location information of the target Internet of Things device through the target inventory device. Therefore, a problem that a network side device cannot obtain a location of the target Internet of Things device in a timely manner can be resolved.

The mobility management apparatus in this embodiment of this application may be an electronic device, for example, an electronic device with an operating system, or may be a component in the electronic device, for example, an integrated circuit or a chip. The electronic device may be a network side device, or another device other than the network side device. For example, the network side device may include but is not limited to the type of the network side device 12 listed above. The another device may be a server, a network attached storage (NAS), or the like. This is not limited in this embodiment of this application.

The mobility management apparatus provided in this embodiment of this application can implement the processes implemented in the method embodiments in FIG. 1 to FIG. 12, and achieve a same technical effect. To avoid repetition, details are not described herein again.

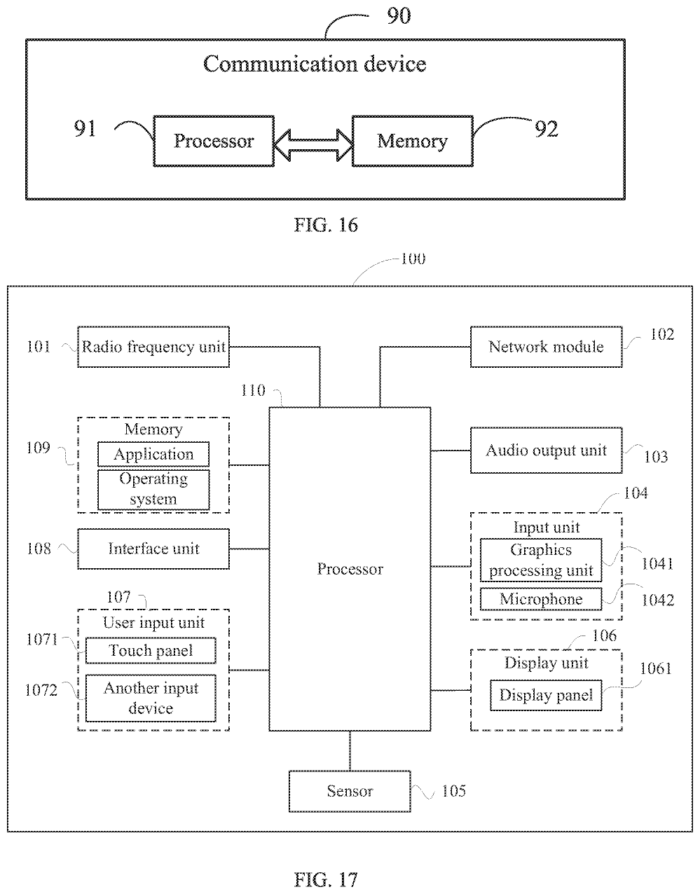

Optionally, in this embodiment of this application, as shown in FIG. 16, an embodiment of this application further provides a communication device 90, including a processor 91 and a memory 92. The memory 92 stores a program or an instruction executable on the processor 91. For example, when the communication device 90 is a terminal, and when the program or the instruction is executed by the processor 91, steps of the foregoing mobility management method embodiment are implemented, and a same technical effect can be achieved. When the communication device 90 is a network side device, and when the program or the instruction is executed by the processor 91, steps of the foregoing mobility management method embodiment are implemented, and a same technical effect can be achieved. To avoid repetition, details are not described herein again.

An embodiment of this application further provides a terminal, including a processor and a communication interface. The communication interface is configured to receive first information from a first network element, where the first information is used to indicate a target inventory device to inventory a target Internet of Things device; and the processor is configured to inventory the target Internet of Things device according to the first information. This terminal embodiment corresponds to the foregoing method embodiment on the terminal side. Each implementation process and implementation of the foregoing method embodiment can be applied to this terminal embodiment, and a same technical effect can be achieved. Optionally, FIG. 17 is a schematic structural diagram of hardware of a terminal according to an embodiment of this application.

The terminal 100 includes but is not limited to components such as a radio frequency unit 101, a network module 102, an audio output unit 103, an input unit 104, a sensor 105, a display unit 106, a user input unit 107, an interface unit 108, a memory 109, and a processor 110.

A person skilled in the art can understand that the terminal 100 may further include the power supply (for example, a battery) that supplies power to each component. The power supply may be logically connected to the processor 110 by using a power supply management system, so as to manage functions such as charging, discharging, and power consumption by using the power supply management system. The terminal structure shown in FIG. 17 constitutes no limitation on the terminal, and the terminal may include more or fewer components than those shown in the figure, or combine some components, or have different component arrangements. Details are not described herein.

It should be understood that, in this embodiment of this application, the input unit 104 may include a graphics processing unit (GPU) 1041 and a microphone 1042, and the graphics processing unit 1041 processes image data of a still image or a video that is obtained by an image capturing apparatus (for example, a camera) in a video capturing mode or an image capturing mode. The display unit 106 may include a display panel 1061. The display panel 1061 may be configured in a form such as a liquid crystal display or an organic light-emitting diode. The user input unit 107 includes at least one of a touch panel 1071 or another input device 1072. The touch panel 1071 is also referred to as a touchscreen. The touch panel 1071 may include two parts: a touch detection apparatus and a touch controller. The another input device 1072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 101 may transmit the downlink data to the processor 110 for processing. In addition, the radio frequency unit 101 may send uplink data to the network side device. Usually, the radio frequency unit 101 includes but is not limited to an antenna, an amplifier, a transceiver, a coupler, a low noise amplifier, a duplexer, and the like.

The memory 109 may be configured to store a software program or an instruction and various data. The memory 109 may mainly include a first storage area for storing a program or an instruction and a second storage area for storing data. The first storage area may store an operating system, and an application or an instruction required by at least one function (for example, a sound playing function or an image playing function). In addition, the memory 109 may be a volatile memory or a non-volatile memory, or the memory 109 may include a volatile memory and a non-volatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 109 in this embodiment of this application includes but is not limited to these memories and a memory of any other proper type.

The processor 110 may include one or more processing units. Optionally, an application processor and a modem processor are integrated into the processor 110. The application processor mainly processes an operating system, a user interface, an application, and the like. The modem processor mainly processes a wireless communication signal, for example, a baseband processor. It can be understood that, alternatively, the modem processor may not be integrated into the processor 110.

The radio frequency unit 101 is configured to receive first information from a first network element, where the first information is used to indicate the terminal to inventory a target Internet of Things device.

The processor 110 is configured to inventory the target Internet of Things device according to the first information.

According to the terminal provided in this embodiment of this application, in a case that a target Internet of Things device exists within coverage of a first network element, the first network element may send first information to the terminal, so that the terminal can inventory the target Internet of Things device, that is, the first network element can obtain location information of the target Internet of Things device through the terminal. Therefore, a problem that a network side device cannot obtain a location of the target Internet of Things device in a timely manner can be resolved.

Optionally, in this embodiment of this application, the processor 110 is further configured to send a target inventory report to the first network element according to a result of inventorying the target Internet of Things device.

The target inventory report is used by the first network element to update a first correspondence, and the first correspondence is a correspondence between the target Internet of Things device and an inventory device.

Optionally, in this embodiment of this application, the first information includes inventory report information, and the inventory report information is used to indicate a target manner in which the terminal sends the target inventory report.

The processor 110 is configured to send the target inventory report to the first network element in the target manner.

The target manner includes at least one of the following: one-time reporting; periodic reporting; performing reporting when the target Internet of Things device is inventoried; reporting a first inventory report; reporting a second inventory report; a reporting period of the target inventory report; a reporting start time of the target inventory report; a reporting end time of the target inventory report; or a reporting frequency of the target inventory report. The first inventory report indicates that the target Internet of Things device is inventoried by the terminal, and the second inventory report indicates that the target Internet of Things device is not inventoried by the terminal.

An embodiment of this application further provides a network side device, including a processor and a communication interface. The communication interface is configured to receive first information from a first network element, where the first information is used to indicate a network side device to inventory a target Internet of Things device; and the processor is configured to inventory the target Internet of Things device according to the first information. This network side device embodiment corresponds to the foregoing method embodiment on the network side device. Each implementation process and implementation of the foregoing method embodiment may be applicable to this network side device embodiment, and a same technical effect can be achieved.

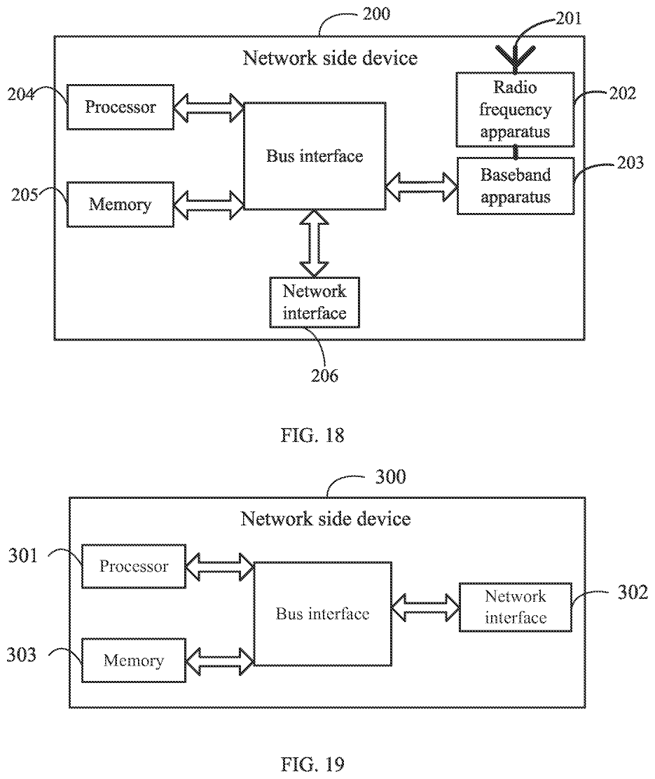

Optionally, an embodiment of this application further provides a network side device. As shown in FIG. 18, the network side device 200 includes an antenna 201, a radio frequency apparatus 202, a baseband apparatus 203, a processor 204, and a memory 205. The antenna 201 is connected to the radio frequency apparatus 202. In an uplink direction, the radio frequency apparatus 202 receives information by using the antenna 201, and sends the received information to the baseband apparatus 203 for processing. In a downlink direction, the baseband apparatus 203 processes information that needs to be sent, and sends processed information to the radio frequency apparatus 202. The radio frequency apparatus 202 processes the received information, and sends processed information by using the antenna 201.

It should be noted that, in a case that the target inventory device is an RAN, the method executed by the network side device (that is, the target inventory device) in the foregoing embodiment may be implemented in the baseband apparatus 203. The baseband apparatus 203 includes a baseband processor.

The baseband apparatus 203 may include, for example, at least one baseband board, where a plurality of chips are disposed on the baseband board. As shown in FIG. 18, one chip is, for example, the baseband processor, is connected to the memory 205 through a bus interface, to invoke a program in the memory 205 to execute the operations of the network device shown in the foregoing method embodiment.

The network side device may further include a network interface 206, and the interface is, for example, a common public radio interface (CPRI).

Optionally, the network side device 200 in this embodiment of the present application further includes an instruction or a program that is stored in the memory 205 and executable on the processor 204. The processor 204 invokes the instruction or the program in the memory 205 to execute the method executed by the modules shown in FIG. 14, and a same technical effect is achieved. To avoid repetition, details are not described herein again.

Optionally, an embodiment of this application further provides a network side device. As shown in FIG. 19, a network side device 300 includes a processor 301, a network interface 302, and a memory 303. The network interface 302 is, for example, a common public radio interface (CPRI).

Optionally, the network side device 300 in this embodiment of the present application further includes an instruction or a program that is stored in the memory 303 and executable on the processor 301. The processor 301 invokes the instruction or the program in the memory 303 to execute the method executed by the modules shown in FIG. 13 or FIG. 15, and a same technical effect is achieved. To avoid repetition, details are not described herein again.

An embodiment of this application further provides a non-transitory readable storage medium. The non-transitory readable storage medium stores a program or an instruction, and when the program or the instruction is executed by a processor, the processes of the foregoing mobility management method embodiment are implemented, and a same technical effect can be achieved. To avoid repetition, details are not described herein again.

The processor is a processor in the terminal in the foregoing embodiment. The non-transitory readable storage medium includes a non-transitory computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing mobility management method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a non-transitory storage medium, and the program/program product is executed by at least one processor to implement the processes of the foregoing mobility management method embodiment, and a same technical effect can be achieved. To avoid repetition, details are not described herein again.

An embodiment of this application further provides a mobility management system, including a terminal and a network side device. The terminal may be configured to execute the steps of the foregoing mobility management method, and the network side device may be configured to execute the steps of the foregoing mobility management method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to execute the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms without departing from the purpose of this application and the protection scope of the claims, all of which fall within the protection of this application.

What is claimed is:

1. A mobility management method, comprising:
determining, by a first network element, first information, wherein the first information is used to indicate a target inventory device to inventory a target Internet of Things device; and
sending, by the first network element, the first information to the target inventory device.

2. The method according to claim 1, wherein the first information comprises at least one of the following: identifier information of the target Internet of Things device, information about the target inventory device, or inventory time information, wherein the inventory time information is time information of inventorying the target Internet of Things device by the target inventory device, wherein
the inventory time information comprises at least one of the following: an inventory period, an inventory start time, an inventory end time, or an inventory frequency.

3. The method according to claim 2, wherein the determining, by a first network element, first information comprises:
determining, by the first network element, the first information according to second information, wherein
the second information comprises at least one of the following:
information about an inventory device within coverage of the first network element;
information about an inventory device currently corresponding to the target Internet of Things device;
a use scenario of the target Internet of Things device;
a service supported by the target Internet of Things device;
a moving track of the target Internet of Things device; or
a working time of the target Internet of Things device.

4. The method according to claim 3, wherein the determining, by the first network element, the first information according to second information comprises:
determining, by the first network element, an inventory range according to the second information, wherein the inventory range comprises information about an inventory device that inventories the target Internet of Things device, wherein
the inventory device that inventories the target Internet of Things device comprises the target inventory device.

5. The method according to claim 3, wherein the method further comprises:
obtaining, by the first network element, the second information from target information, wherein
the target information comprises at least one of the following: local storage information, operator configuration information, information from an Internet of Things service provider, information from an operator management network element, or information about an inventory device registered with the first network element; and
the information from the Internet of Things service provider comprises at least one of the following:
the identifier information of the target Internet of Things device;
the use scenario of the target Internet of Things device;
the service supported by the target Internet of Things device;
the moving track of the target Internet of Things device; or
the working time of the target Internet of Things device.

6. The method according to claim 5, wherein the method further comprises:
receiving, by the first network element, the target information from a second network element, wherein
the second network element comprises any one of the following: a unified data management network element and a policy control function network element.

7. The method according to claim 1, wherein the method further comprises:
receiving, by the first network element, a target inventory report from the target inventory device, wherein the target inventory report comprises a result of inventorying the target Internet of Things device by the target inventory device.

8. The method according to claim 7, wherein the method further comprises:
updating, by the first network element, a first correspondence according to the target inventory report, wherein
the first correspondence is a correspondence between the target Internet of Things device and an inventory device.

9. The method according to claim 8, wherein the first correspondence is a correspondence between the target Internet of Things device and a first inventory device; and
the first inventory device is an inventory device that is stored in the first network element and that is capable of inventorying the target Internet of Things device.

10. The method according to claim 9, wherein the method further comprises:
receiving, by the first network element, identifier information of the target Internet of Things device from the first inventory device; and
storing, by the first network element, the first correspondence.

11. The method according to claim 8, wherein the target inventory report is a first inventory report, and the first inventory report indicates that the target Internet of Things device is inventoried; and
the updating, by the first network element, a first correspondence according to the target inventory report comprises:
updating, by the first network element, the first correspondence to a second correspondence according to the target inventory report, wherein
the second correspondence is a correspondence between the target Internet of Things device and the target inventory device.

12. The method according to claim 7, wherein the target inventory report comprises at least one of the following:
identifier information of the target Internet of Things device; or
a target inventory indication, wherein
the target inventory indication is used to indicate any one of the following that: the target Internet of Things device is inventoried by the target inventory device, and the target Internet of Things device is not inventoried by the target inventory device;
or,
the first information comprises inventory report information, and the inventory report information is used to indicate a target manner in which the target inventory device sends the target inventory report, wherein
the target manner comprises at least one of the following:
one-time reporting;
periodic reporting;
performing reporting when the target Internet of Things device is inventoried;
reporting a first inventory report;
reporting a second inventory report;
a reporting period of the target inventory report;
a reporting start time of the target inventory report;
a reporting end time of the target inventory report; or
a reporting frequency of the target inventory report, wherein
the first inventory report indicates that the target Internet of Things device is inventoried, and the second inventory report indicates that the target Internet of Things device is not inventoried.

13. A mobility management method, comprising:
receiving, by a target inventory device, first information from a first network element, wherein the first information is used to indicate the target inventory device to inventory a target Internet of Things device; and
inventorying, by the target inventory device, the target Internet of Things device according to the first information.

14. The method according to claim 13, wherein the first information comprises at least one of the following: identifier information of the target Internet of Things device, information about the target inventory device, or inventory time information, wherein the inventory time information is time information of inventorying the target Internet of Things device by the target inventory device; and
the inventory time information comprises at least one of the following: an inventory period, an inventory start time, an inventory end time, or an inventory frequency.

15. The method according to claim 14, wherein the first information is determined by the first network element according to second information, wherein
the second information comprises at least one of the following:
information about an inventory device within coverage of the first network element;
information about an inventory device currently corresponding to the target Internet of Things device;
a use scenario of the target Internet of Things device;
a service supported by the target Internet of Things device;
a moving track of the target Internet of Things device; or
a working time of the target Internet of Things device.

16. The method according to claim 13, wherein the method further comprises:
sending, by the target inventory device, a target inventory report to the first network element according to a result of inventorying the target Internet of Things device, wherein
the target inventory report is used by the first network element to update a first correspondence, and the first correspondence is a correspondence between the target Internet of Things device and an inventory device.

17. The method according to claim 16, wherein the first correspondence is a correspondence between the target Internet of Things device and a first inventory device; and
the first inventory device is an inventory device that is stored in the first network element and that is capable of inventorying the target Internet of Things device.

18. The method according to claim 16, wherein the target inventory report comprises at least one of the following:
identifier information of the target Internet of Things device; or
a target inventory indication, wherein
the target inventory indication is used to indicate any one of the following that: the target Internet of Things device is inventoried by the target inventory device, and the target Internet of Things device is not inventoried by the target inventory device;
or,
the first information comprises inventory report information, and the inventory report information is used to indicate a target manner in which the target inventory device sends the target inventory report; and
the sending a target inventory report to the first network element comprises:
sending, by the target inventory device, the target inventory report to the first network element in the target manner, wherein
the target manner comprises at least one of the following:
one-time reporting;
periodic reporting;
performing reporting when the target Internet of Things device is inventoried;
reporting a first inventory report;
reporting a second inventory report;
a reporting period of the target inventory report;
a reporting start time of the target inventory report;
a reporting end time of the target inventory report; or
a reporting frequency of the target inventory report, wherein
the first inventory report indicates that the target Internet of Things device is inventoried by the target inventory device, and the second inventory report indicates that the target Internet of Things device is not inventoried by the target inventory device.

19. A first network element, comprising a processor and a memory, wherein the memory stores a program or an instruction executable on the processor, and the program or the instruction, when executed by the processor, causes the first network element to perform:
determining first information, wherein the first information is used to indicate a target inventory device to inventory a target Internet of Things device; and
sending the first information to the target inventory device.

20. A terminal, comprising a processor and a memory, wherein the memory stores a program or an instruction executable on the processor, and when the program or the instruction is executed by the processor, steps of the mobility management method according to claim 13 are implemented.
